(19) United States
(12) Patent Application Publication
(10) Pub. No.: US 2011/0158445 A1
(43) Pub. Date: Jun. 30, 2011

(54) DIPOLE LOUDSPEAKER WITH ACOUSTIC WAVEGUIDE

(75) Inventors: Jan Abildgaard Pedersen, Holstebro (DK); Henrik Green Mortensen, Viborg (DK)

(73) Assignee: SL Audio A/S, Skive (DK)

(21) Appl. No.: 12/994,840

(22) PCT Filed: May 26, 2009
(86) PCT No.: PCT/DK09/50118

§ 371 Date: Feb. 22, 2011

(30) Foreign Application Priority Data
May 27, 2008 (EP) 08104111.3

(51) Int. Cl. H04R 1/20

(52) U.S. Cl. 381/337

(57) ABSTRACT

A loudspeaker based on a dipole element (DE) with at least one diaphragm arranged to generate an acoustic dipole signal according to an electric signal, e.g. a dedicated dipole driver such as an Air Motion Transformer or a combination of two monopole drivers, e.g. dome tweeters, mounted back to back close together. An acoustic waveguide (WG) is arranged in relation to the dipole element (DE) such that a surface (S) of the acoustic waveguide (WG) is close to the at least one diaphragm of the dipole element (DE). The acoustic waveguide (WG) extends in both directions of a main axis (MA) of the dipole element (DE), thus serving to guide the acoustic dipole signals away from the dipole element (DE). Preferably, the surface (S1, S2) of the acoustic waveguide (WG) has a general tilt of less than 30° in relation to the main axis (MA). Thereby, a diffuse sound field is provided with only a limited requirement for housing the acoustic waveguide (WG) in the depth dimension. A smooth sound radiation for directions away from on-axis is provided, and sound radiation on-axis is highly suppressed. With these properties the loudspeaker is suited as back or surround loudspeaker in surround sound systems to cover midrange and/or upper audio frequencies.

### FIELD OF THE INVENTION

The invention relates to the field of audio equipment, especially loudspeakers for reproduction of audio signals. More specifically, the invention relates to the field of hi-fi loudspeakers, especially hi-fi loudspeakers suitable for reproduction of surround channels or back channels of surround sound signals. The invention defines a loudspeaker capable of providing a diffuse high frequency audio reproduction, the loudspeakers are suitable for in-wall or on-wall mounting.

### BACKGROUND OF THE INVENTION

To provide a listener with the capability of experiencing 3D spatial audio image in home audio systems, surround sound audio systems have become popular. In such systems more than the traditional two stereo loudspeakers are included. Standardized surround sound signals such as 5.1 or 7.1 surround sound configurations, include dedicated surround channels (e.g. in a 5.1 configuration) or both back channels and surround channels (e.g. in a 7.1 configuration). Back channels are intended for reproduction by loudspeakers placed behind the listener, while surround channels are intended for reproduction by loudspeakers placed to the sides of the listener.

Loudspeakers suited for reproduction of stereo channels or front channels of surround sound signals are normally designed to provide a precise reproduction of high audio frequencies directed towards the listener. Hereby the influence of room reflections at high audio frequencies is suppressed relative to the direct sound reaching the listener, and this results in a rather precise audio image in front of the listener. Most often, loudspeakers used to reproduce surround and back channels in surround sound systems are traditional small hi-fi loudspeakers with high frequency drivers directed towards the listener. However, in fact such loudspeakers are not suited for optimal reproduction of surround and back channels, since these channels are intended to provide the listener with a rather diffuse spatial effect and not a precise localization. Thus, to obtain this, it is preferred that the listener is unable to locate the position of the surround and back loudspeakers. In other words, it is preferred that these loudspeakers provide a diffuse sound reproduction which is not directed towards the listener. This is especially important at mid and high audio frequencies, especially above 2-3 kHz.

Several types of surround/back channel loudspeakers exist, which are designed to provide a diffuse reproduction at high audio frequencies. Such loudspeakers include systems based on a single high frequency driver provided with a dispersion lens and/or the use of acoustic damping material to suppress sound directly towards the listener. Alternatively, a plurality of high frequency drivers are used, each directed away from the listener and possibly supplied with electronic means to provide an electric phase difference between the high frequency drivers.

However, common for existing surround/back channel loudspeakers is that a considerable space is required to provide a diffuse high frequency reproduction. In relation to home applications this is especially a problem in relation to the depth dimension of the loudspeaker, since it is normally required that a loudspeaker suited for on-wall or in-wall mounting is very flat in order not to intrude the interior of a living room.

### SUMMARY OF THE INVENTION

Thus, according to the above explanation, it is an object of the present invention to provide a simple loudspeaker capable of providing a diffuse reproduction of higher audio frequencies, so as to provide an audio reproduction suitable for surround channel and/or back channel of surround sound signals.

According to a first aspect, the invention provides a loudspeaker including
a dipole element with at least one diaphragm arranged to generate an acoustic dipole signal according to an electric signal, and
an acoustic waveguide arranged in relation to the dipole element such that a surface of the acoustic waveguide is close to the at least one diaphragm of the dipole element, wherein the acoustic waveguide extends in both directions of a main axis of the dipole element.

By ‘acoustic dipole signal’ from the dipole element is understood an acoustic signal that exhibits a direction where there is substantially zero acoustic radiation, e.g. the on-axis direction understood as the direction towards the listener when the loudspeaker is oriented as intended during normal use. To one side of this direction the acoustic pressure is positive while the acoustic pressure is negative to the other side this direction. Substantially perpendicular to the direction of zero acoustic radiation, there will be a maximum acoustic pressure. Preferably, the acoustic dipole signal is characterized by, in a certain frequency range, the level will be at least 20 dB lower measured in the zero acoustic direction, e.g. substantially on-axis, than the level measured in a direction where the maximum level can be observed.

By ‘main axis’ of the dipole element is understood an axis parallel to a motion of the air in front of the at least one sound radiating diaphragm, i.e. an axis perpendicular to a plane defined by the diaphragm in case the diaphragm is substantially flat. In operation, the loudspeaker will provide the best performance when positioned with the main axis of the dipole element being substantially perpendicular to the direction towards the listener, thus providing substantially zero acoustic response directly towards the listener.

By ‘close to the at least one diaphragm’ is understood that the surface of the acoustic waveguide should be positioned so close to the dipole element, compared to the wavelength, that an appropriate acoustic coupling between mechanical vibrations of the diaphragm(s) and the acoustic waveguide is provided. Hereby, the acoustic waveguide will most effectively transform mechanical energy from the dipole element into acoustic energy, thus providing a high electro-acoustic sensitivity of the loudspeaker—especially compared to prior art designs where a desired directional pattern is obtained by providing acoustic damping material to absorb part of the acoustic energy radiated from the driver.

The loudspeaker is especially suited for reproduction of high audio frequencies in surround and back channel loudspeaker systems. The reason is that the dipole element provides a highly diffuse sound reproduction itself, and due to the interaction with the waveguide which can be formed by geometrically simple structure, it is ensured that sound reproduction is directed away from a centre axis of the loudspeaker. Especially, the use of the dipole element enables the use of a very flat acoustic waveguide which allows a low total depth of the loudspeaker. Hereby the loudspeaker is highly suited for both in-wall and on-wall mounting in a normal living room. Further, the use of a dipole element provides a diffuse sound filed without the need for an electronic circuit or signal processing to provide a phase difference between two or more monopole drivers, as in prior art loudspeakers.

The acoustic characteristics of the loudspeaker provides an excellent acoustic match in case of in-wall mounting flush a surface of a wall, however the characteristics will also produce highly diffuse sound in configurations where the loudspeaker is mounted on a surface of a wall, or in case the loudspeaker is positioned in a room away from the walls.

In preferred embodiment, the surface of the acoustic waveguide has a substantially smooth surface with a curvature serving to provide a gradual transition between the area near the dipole element and a peripheral area of the acoustic waveguide, so as to guide acoustic waves away from the dipole element. The surface of the acoustic waveguide may include a substantially plane portion extending from an area near the dipole element to the peripheral area of the acoustic waveguide. The substantially plane portion is tilted less than 30°, such as 20-25°, such as less than 20°, such as 15-20°, such as 10-15°, relative to the main axis of the dipole element. Such rather flat designs of the acoustic waveguides provide a diffuse sound radiation in a wide angular range all the way to perpendicular to on-axis. Further, a small depth dimension of the loudspeaker is provided.

The surface of the acoustic waveguide in an area near the dipole element is preferably tilted less than 30°, such as less than 20°, such as less than 10°, such as 5°-10°, such as 1°-5°, relative to the main axis of the dipole element. Especially, the surface of the acoustic waveguide in the area near the dipole element is substantially parallel with a plane defined by a periphery of the acoustic waveguide. Such low or very low tilt or even flat portion of the acoustic waveguide surface near the dipole element provides a good acoustic coupling between the dipole element diaphragm(s) and the acoustic waveguide.

Preferably, a major axis of extension of the acoustic waveguide is substantially parallel to the main axis of the dipole element. Thus, the acoustic waveguide preferably extends mostly in a direction serving to guide acoustic waves away from the dipole element.

Preferably, the acoustic waveguide has a length in its major axis of extension which is at least 2 times, such as 2.5 times, such as 3 times, such as 4 times, such as 5 times, a distance between the surface of the acoustic waveguide in the area near the dipole element and the surface of a peripheral area of the acoustic waveguide. This means that the acoustic waveguide is preferably rather flat.

The acoustic waveguide may be substantially symmetrical around a plane perpendicular to the main axis of the dipole element. Additionally or alternatively, the acoustic waveguide may be substantially symmetrical around a plane which goes through the main axis of the dipole element. Such symmetric shapes are rather easy to manufacture, but for different reasons asymmetric shapes may be preferred.

The dipole element and the acoustic waveguide may be dimensioned such that at least a portion of the at least one diaphragm of the dipole element projects in front of a plane defined by a periphery of the acoustic waveguide. Alternatively, the dipole element is positioned in relation to the acoustic waveguide such that the at least one diaphragm of the dipole element is positioned behind a plane defined by a periphery of the acoustic waveguide.

The acoustic waveguide may have, along part of its periphery, a surface defining a plane which is tilted less than 30°, such as less than 20°, such as less than 10° in relation to a plane defined by a periphery of the acoustic waveguide.

It is preferred that the acoustic waveguide is shaped so as to provide a substantially smooth and desired polar pattern of acoustic radiation from the loudspeaker. As mentioned, it is normally preferable that the direction of minimum sound pressure level is substantially on-axis, i.e. in a direction towards or almost towards the listener, during normal operation. E.g. the acoustic waveguide can be designed so as to provide the desired size of the direction range where the acoustic output from the loudspeaker is highly suppressed.

The dipole element may include two acoustic monopole drivers, such as two identical acoustic monopole drivers. These two acoustic monopole drivers may be two dome tweeters, e.g. identical dome tweeters, positioned close together and oriented such their diaphragms face in substantially opposite directions, and wherein the two acoustic monopole drivers are electrically connected such that their diaphragms move substantially in anti-phase, during operation.

Alternatively, the dipole element may be formed by a single driver. Such driver may include a driver being one of: an Air Motion Transformer (AMT), an electro-dynamic driver, an electro-static driver, and an electro-magnetic driver.

A suitable dipole driver for use as the dipole element is the so-called Air Motion Transformer (AMT) type driver. An AMT driver has a diaphragm, folded into accordion-like pleats to which e.g. aluminium foil strips are bonded. This diaphragm is mounted in an intense magnetic field or driven by a piezoelectric element, and it is driven from its edge so that its folds move the air and thus produce sound. This design does not require a large magnets and voice coils, and it allows the driver's resonant frequency to be outside the frequency band it reproduces. When an electric audio signal is applied, the pleats alternately expand and contract in a bellows-like manner, forcing air out of the pleats on one side and sucking in on the other side. Thus, such AMT driver is suitable as a dipole element.

Preferably, the dipole element is arranged to generate an acoustic dipole signal up to at least 2 kHz, such as up to at least 3 kHz, such as up to at least 5 kHz, i.e. at least up to midrange frequencies, such as upper midrange frequencies, e.g. upper audio frequencies.

The loudspeaker may include a cabinet in which the acoustic waveguide and dipole element are mounted, e.g. with the acoustic waveguide mounted with its periphery flush with a front baffle of the cabinet.

The loudspeaker is preferably arranged for at least one of: in-wall mounting, mounting on a surface of a wall, mounting on a surface of a ceiling.

The loudspeaker may have the dipole element arranged for generating acoustic signals in at least a frequency range being one of: mid frequency range, upper frequency range, while at least one loudspeaker driver is included, arranged for generating an acoustic signal in a frequency range below the frequency range in which the dipole element is arranged for.

The loudspeaker may be arranged for reproducing at least one of: a back channel of a surround sound signal, a surround channel of a surround sound signal, thus utilizing the diffuse sound field radiation properties of the loudspeaker.

In a second aspect, the invention provides a surround sound loudspeaker system including one or more front loudspeakers, and at least one loudspeaker according to the first aspect.

In a third aspect, the invention provides a method for reproducing a surround sound signal to a listener, the method including
arranging a loudspeaker according to the first aspect in relation to the listener, such as orienting the loudspeaker such that the main axis of the dipole element provides an angle of more than 50° with a line between the listener and the dipole element, and
applying one of: a back channel and a surround channel of the surround sound signal to the dipole element.

It is appreciated that any advantage mentioned for the first aspect applies as well for the second and third aspects. Further, any sub aspect mentioned in connection with the first aspect may in any way be combined with the second or third aspects.

### BRIEF DESCRIPTION OF DRAWINGS

In the following, the invention will be described in more details by referring to embodiments illustrated in the accompanying drawings, of which

FIG. 1 illustrates top view section and front view sketches of an acoustic waveguide embodiment,

FIG. 2 illustrates a top view section sketch of another acoustic waveguide shape,

FIG. 3 illustrates a top view section of yet another embodiment with another acoustic waveguide shape and with a dipole element formed by two back to back mounted dome tweeters,

FIG. 4 illustrates a detailed drawing of an embodiment based on an AMT based dipole driver, and

FIG. 5 illustrates a 3D view of a complete loudspeaker system in a cabinet, including the high frequency loudspeaker shown in FIG. 4, and

FIG. 6 illustrates polar plots of the acoustic response from the loudspeaker embodiment of FIGS. 4 and 5, at 2, 4 and 6 kHz.

### DETAILED DESCRIPTION OF THE INVENTION

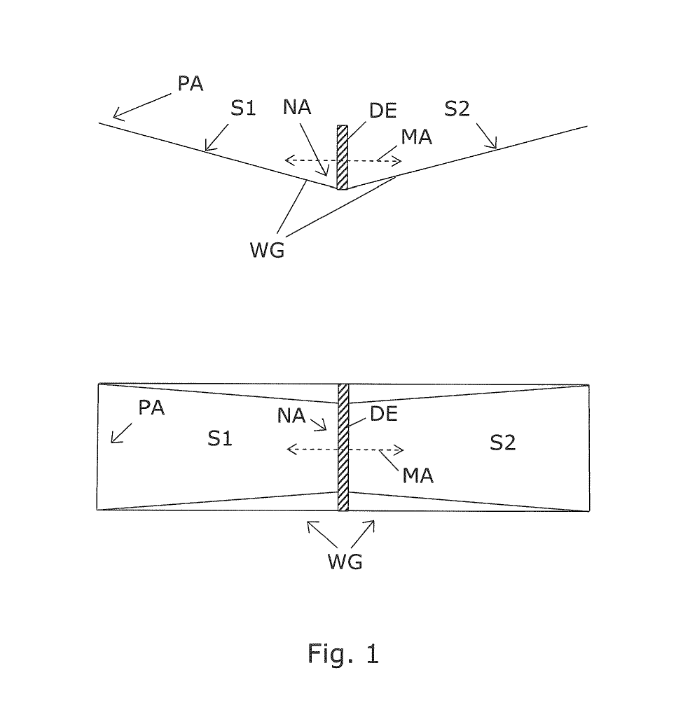

FIG. 1, upper sketch, illustrates a section of a rather simple loudspeaker embodiment according to the invention, while a front view is illustrated in FIG. 1, lower sketch.

A dipole element DE, e.g. an Air Motion Transformer (AMT) based driver, is arranged in connection with an acoustic waveguide WG of acoustically substantially reflecting material. In the illustrated embodiment, the acoustic waveguide WG is symmetrical in relation to the dipole element DE. A main axis MA of the dipole element is indicated on the sketch to show the orientation of the dipole element DE. Preferably, the dipole element DE is arranged such in relation to the acoustic waveguide WG, that its diaphragm or diaphragms is/are positioned close enough to the surface S1, S2 of the acoustic waveguide WG that an appropriate acoustic coupling is provided. The shape of the acoustic waveguide WG should be such that the acoustic dipole signals from the dipole element DE are guided smoothly away from the dipole element DE in order to provide a highly diffuse sound field from the loudspeaker, still with a rather smooth polar acoustic radiation pattern on both sides of on-axis, where the sound pressure level will be minimum.

The illustrated waveguide WG has plane surfaces S1, S2 starting from the area NA near the dipole element DE and extending all the way to a peripheral area PA of the acoustic waveguide WG. The plane surfaces S1, S2 are preferably tilted less than 30°, e.g. 20°-25° or lower, in relation to the main axis MA of the dipole element DE. Thus, as also illustrated, the section of the acoustic waveguide WG is preferably rather flat, e.g. shaped as a very flat horn. This provides a highly diffuse sound radiation from the loudspeaker, and at the same time this design enables a low depth dimension which makes the loudspeaker suitable for different types of mounting either on-wall or in-wall.

The acoustic waveguide WG can be formed in various materials, e.g. a polymeric material, an MDF board, wood, a metal, and the like. The acoustic waveguide WG may include integrated mounting facilities for the dipole element. The acoustic waveguide WG may be mounted directly in a baffle, e.g. with its periphery flush with the baffle.

In some embodiments, the dipole element DE may extend in a direction perpendicular to the main axis MA beyond the periphery of the acoustic waveguide WG, i.e. when mounted for normal use, the dipole element may project in front of a plane defined by the periphery of the acoustic waveguide. Especially, the dipole element DE and the acoustic waveguide WG may be matched such that the extension of the diaphragm(s) of the dipole element DE in a direction perpendicular to the main axis MA corresponds to the extension of the acoustic waveguide WG in the same direction. However, it may also be preferred that the periphery of the acoustic waveguide WG extends in a direction perpendicular to the main axis MA beyond an extension of the dipole element DE.

FIG. 1, lower sketch indicates with its front view that the acoustic waveguide WG extends more in a direction of the main axis MA of the dipole element DE than in a direction perpendicular thereto. Thus, the acoustic waveguide WG may extend 2-3 times, or more, in the main axis MA direction than in the direction perpendicular thereto. The acoustic waveguide WG may be shaped such that the surfaces S1, S2 become gradually wider away from the dipole element DE.

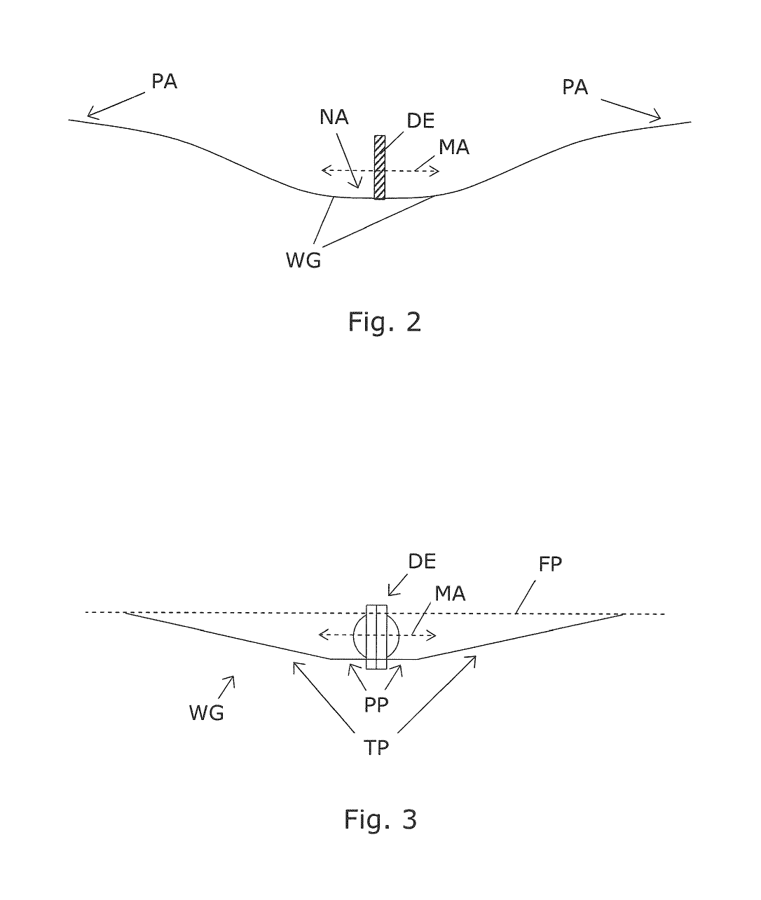

FIG. 2 illustrates a section sketch of an embodiment with an acoustic waveguide WG which has a surface with a curved section in contrast to the plane surfaces S1, S2 of the embodiment in FIG. 1. As illustrated, the surface in the area NA near the dipole element DE is substantially parallel with the main axis MA, while it gradually tilts slightly more in relation to the main axis MA away from the dipole element DE up to a certain point, and further away from the dipole element DE, the tilt gradually decreases, ending at a very low tilt, e.g. less than 10°, in the peripheral area PA of the acoustic waveguide WG.

FIG. 3 illustrates yet another section sketch of an embodiment with an acoustic waveguide WG which has a surface formed by two plane parts with different tilt in relation to the main axis MA. In the illustrated embodiment the parts are: 1) a parallel part PP in the area near the dipole element DE, this parallel part PP having a surface parallel with the main axis MA (i.e. a tilt of 0°), and 2) a tilting part TP connected to the parallel part PP, the tilting part TP having a surface tilted such as 20°-30° in relation to the main axis MA. The parallel part may have an extension in a direction parallel with the main axis MA of only 2-3 mm, or up to as much as 5-10 cm or even more. It is to be understood of course, that the parallel part PP may in fact have a tilt of such as 1°-5° still with substantially the same effect of providing a good acoustic coupling to the dipole element DE.

In FIG. 3, the dipole element DE is illustrated as formed by two monopole drivers, namely two dome tweeters mounted back to back close together, and electrically connected in anti-phase, such that their diaphragms move in the same direction. With such configuration, it will be possible to provide an acceptable dipole effect up to a few kHz, even though a certain distance between their diaphragms is of course inevitable. As illustrated the dome tweeters DE are positioned such that their diaphragms occupy substantially the entire extension of the acoustic waveguide WG in a direction perpendicular to the main axis MA. This means that an outer part of the dome tweeters protrudes in front of a front plane FP defined by a peripheral part of the acoustic waveguide WG.

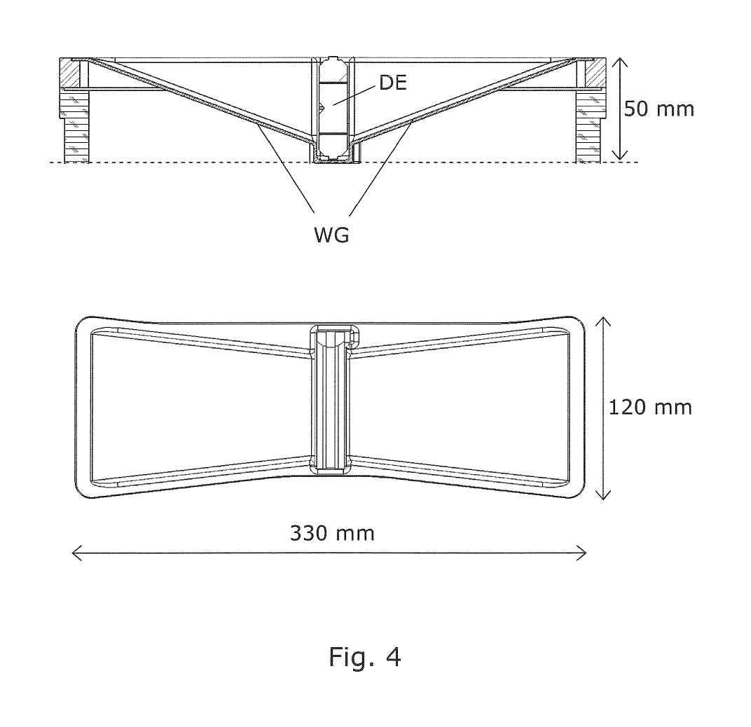

FIG. 4 illustrates section and front view drawings of yet another embodiment with an acoustic waveguide WG which has a surface substantially formed by one plane surface on each side of the dipole element DE, i.e. similar to the sketch of FIG. 1. Vital dimensions on this specific embodiment are indicated. With the indicated dimensions of the acoustic waveguide WG, the plane parts of the acoustic waveguide WG has a tilt of 16-17° in relation to the main axis of the dipole element DE. As seen, the dipole element DE, in this embodiment formed by an AMT driver, protrudes slightly in front of a front plane defined by the periphery of the acoustic waveguide WG.

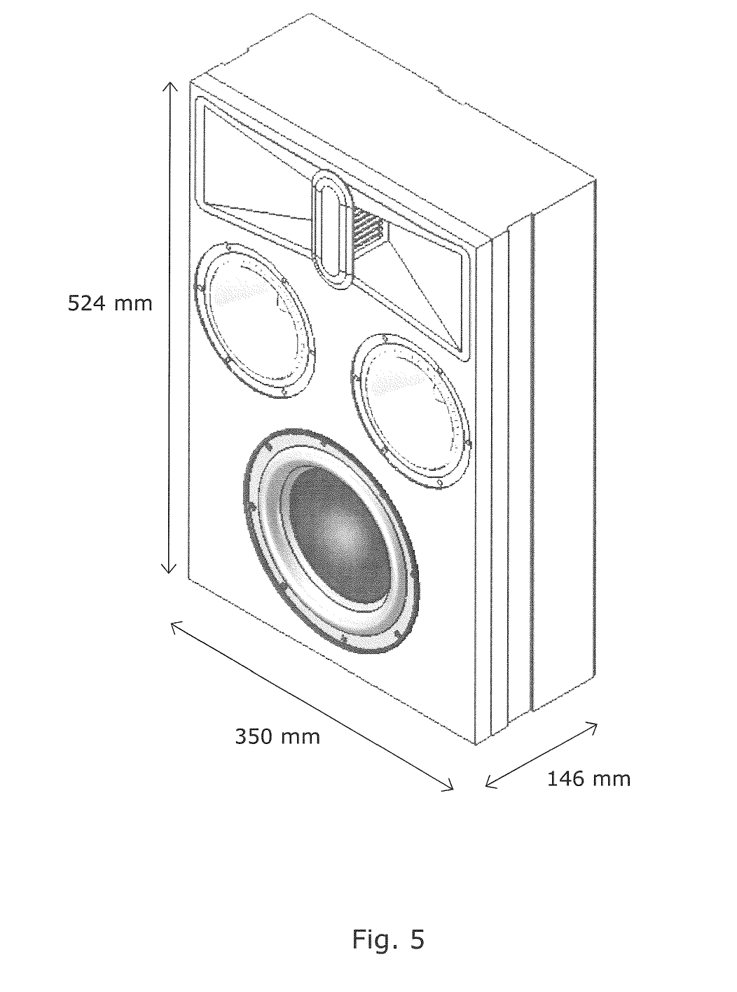

FIG. 5 illustrates a 3D view of a complete full-range surround or back channel loudspeaker with a rather flat cabinet housing one loudspeaker according to the invention, namely the loudspeaker illustrated in FIG. 4. This loudspeaker functions as a high frequency and upper midrange loudspeaker, since it is electrically connected via a cross-over network with a cross-over frequency of 1 kHz. The high frequency and upper midrange loudspeaker is mounted flush with the front baffle of the cabinet, and in an upper part of this baffle. As seen, the high frequency and upper midrange loudspeaker is matched with the front baffle dimensions, such that the high frequency and upper midrange loudspeaker extends close to the upper and side edges of the front baffle.

Below the high frequency and upper midrange loudspeaker, two conventional 5″ midrange drivers with cone shaped diaphragms are positioned. Finally, one 8″ bass driver occupies a lower portion of the front baffle.

Outer dimensions of the cabinet are indicated. With a depth of less than 150 mm, even with a bass driver included, the complete loudspeaker is suited for on-wall mounting e.g. on a wall behind a listener. Further, the front baffle itself or the entire cabinet may be mounted in-wall, i.e. in a hole in a wall, such that the front baffle is substantially flush with the surface of the wall. Without a bass driver, the high frequency and upper midrange loudspeaker of FIG. 4 can itself be mounted in a cabinet having a total depth of less than 80 mm.

Even though all illustrated embodiments have symmetric acoustic waveguides, it is to be understood that the acoustic waveguide does not need to be perfectly symmetrical to provide a diffuse sound field. E.g. it may be preferred to produce loudspeakers with anti-symmetric acoustic waveguides in order to provide dedicated left and right loudspeakers that have laterally asymmetric acoustic waveguides.

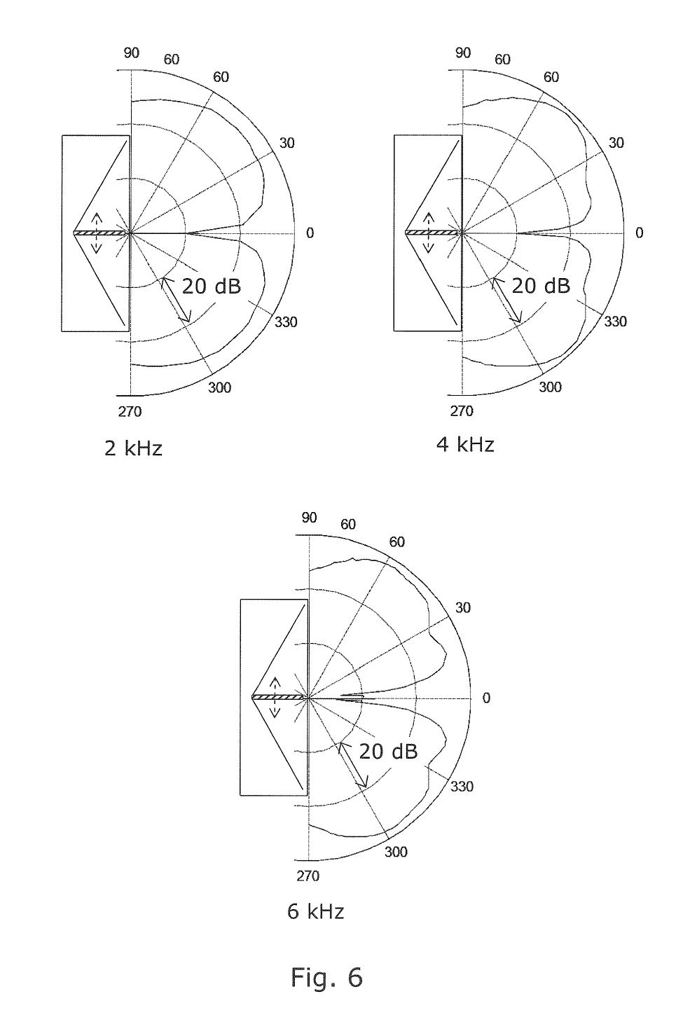

FIG. 6 illustrates three polar sound radiation patterns simulated for the loudspeaker of FIGS. 4 and 5 illustrating the sound level radiated from the loudspeaker at 2 kHz, 4 kHz, and 6 kHz, respectively, in different directions indicated in degrees)(°). Sketches of a section of the loudspeakers with the main axis of the dipole element indicated with a double arrow helps to illustrate the orientation of the loudspeaker. Mounted in normal operation, the radiated patterns correspond to a horizontal plane. 0° is “on-axis”, i.e. directly in front of the centre of loudspeaker, and the angle increases positively anti-clockwise. 90° and 270° indicated directions to the sides, i.e. perpendicular to on-axis.

As seen, for all illustrated frequencies a significant level dip is seen on-axis, in all case above the on-axis level is significantly below 20 dB lower than 90° to the sides. Thus, in the frequency range 2-6 kHz the loudspeaker will produce a rather diffuse sound radiation directed away from on-axis. Further, it is noticed that a rather smooth radiation pattern can be observed from 10-15° all the way to perpendicular to on-axis thus ensuring an equal spreading of sound in a wide range of directions which benefits the experience of a diffuse surround sound when serving as back channel or surround channel loudspeaker in a surround sound system.

To sum up, the invention provides a loudspeaker based on a dipole element (DE) with at least one diaphragm arranged to generate an acoustic dipole signal according to an electric signal, e.g. a dedicated dipole driver such as an Air Motion Transformer or a combination of two monopole drivers, e.g. dome tweeters, mounted back to back close together. An acoustic waveguide (WG) is arranged in relation to the dipole element (DE) such that a surface (S) of the acoustic waveguide (WG) is close to the at least one diaphragm of the dipole element (DE). The acoustic waveguide (WG) extends in both directions of a main axis (MA) of the dipole element (DE), thus serving to guide the acoustic dipole signals away from the dipole element (DE). Preferably, the surface (51, S2) of the acoustic waveguide (WG) has a general tilt of less than 30° in relation to the main axis (MA). Thereby, a diffuse sound field is provided with only a limited requirement for housing the acoustic waveguide (WG) in the depth dimension. A smooth sound radiation for directions away from on-axis is provided, and sound radiation on-axis is highly suppressed. With these properties the loudspeaker is suited as back or surround loudspeaker in surround sound systems to cover midrange and/or upper audio frequencies.

Although the present invention has been described in connection with the specified embodiments, it is not intended to be limited to the specific form set forth herein. Rather, the scope of the present invention is limited only by the accompanying claims. In the claims, the term “comprising” or “including” does not exclude the presence of other elements. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A loudspeaker comprising:
a dipole element (DE) with at least one diaphragm arranged to generate an acoustic dipole signal according to an electric signal, and
an acoustic waveguide (WG) arranged in relation to the dipole element (DE) such that a surface (S) of the acoustic waveguide (WG) is close to the at least one diaphragm of the dipole element (DE) compared to a wavelength of the acoustic dipole signal, wherein the acoustic waveguide (WG) extends in both directions of a main axis (MA) of the dipole element (DE), wherein the surface (S) of the acoustic waveguide (WG) has a substantially smooth surface with a curvature serving to provide a gradual transition between the area (NA) near the dipole element (DE) and a peripheral area (PA) of the acoustic waveguide (WG), so as to guide acoustic waves away from the dipole element, wherein the surface (S) of the acoustic waveguide (WG) includes a substantially plane portion (S1, S2) extending from an area (NA) near the dipole element (DE) to the peripheral area (PA) of the acoustic waveguide (WG), and wherein the substantially plane portion (S1, S2) is tilted less than 30°, such as less than 20°, such as less than 15°, relative to the main axis (MA) of the dipole element (DE).

2-12. (canceled)

13. The loudspeaker according to claim 1, wherein a major axis of extension of the acoustic waveguide (WG) is substantially parallel to the main axis (MA) of the dipole element (DE).

14. The loudspeaker according to claim 1, wherein the acoustic waveguide (WG) is substantially symmetrical in relation to the dipole element (DE).

15. The loudspeaker according to claim 1, wherein at least a portion of the at least one diaphragm of the dipole element (DE) projects in front of a plane (FP) defined by a periphery of the acoustic waveguide (WG).

16. The loudspeaker according to claim 1, wherein the dipole element (DE) is positioned in relation to the acoustic waveguide (WG) such that the at least one diaphragm of the dipole element (DE) is positioned behind a plane (FP) defined by a periphery of the acoustic waveguide (WG).

17. The loudspeaker according to claim 1, wherein the acoustic waveguide (WG) has along part of its periphery a surface (S) defining a plane (TP) which is tilted less than 30°, such as less than 20°, in relation to a plane (FP) defined by a periphery of the acoustic waveguide (WG).

18. The loudspeaker according to claim 1, wherein the dipole element (DE) includes two acoustic monopole drivers (D1, D2), such as two identical acoustic monopole drivers.

19. The loudspeaker according to claim 18, wherein the two acoustic monopole drivers are two dome tweeters (D1, D2), such as identical dome tweeters (D1, D2), positioned close together and oriented such their diaphragms face in substantially opposite directions, and wherein the two acoustic monopole drivers are electrically connected such that their diaphragms move substantially in anti-phase, during operation.

20. The loudspeaker according to claim 1, wherein the dipole element (DE) is formed by a single driver.

21. The loudspeaker according to claim 1, wherein the dipole element (DE) includes a driver being one of: an air motion transformer, an electro-dynamic driver, an electro-static driver, and an electro-magnetic driver.

22. The loudspeaker according to claim 1, wherein the dipole element (DE) is arranged to generate an acoustic dipole signal up to at least 3 kHz, such as up to at least 5 kHz.
